(19) United States
(12) Patent Application Publication
(10) Pub. No.: US 2006/0020436 A1
(43) Pub. Date: Jan. 26, 2006

(54) Centrifugal clutch balanced design

(75) Inventors: Kenneth V. Bechtold, Freeport, IL (US); Wayne A. Lamb, Freeport, IL (US)

Correspondence Address: Intellectual Property;Honeywell International, Inc.,, 101 Columbia Rd., P.O Box 2245, Morristown, NJ, 07962, US

(73) Assignee: Honeywell International, Inc.

(21) Appl. No.: 10/955,313

(22) Filed: Sep. 30, 2004

Related U.S. Application Data
(60) Provisional application No. 60/590,708, filed on Jul. 23, 2004.

(51) Int. Cl. G06G 7/48

(52) U.S. Cl. 703/7

(57) ABSTRACT

A methodology and system for balancing a centrifugal clutch can be implemented that includes a 3-dimensional model of a centrifugal clutch assembly in an engaged position thereof. A mass center of the centrifugal clutch assembly can be calculated, and a distance from the axis of rotation of the centrifugal clutch assembly can be determined. Thereafter, associated part features of the centrifugal clutch assembly can be modified in order to move the mass center; and repeating as necessary establishing a 3-dimensional model of a centrifugal clutch assembly in an engaged position thereof, calculating a mass center of the centrifugal clutch assembly, determining a particular distance from an axis of rotation of the centrifugal clutch assembly, and modifying part features of the centrifugal clutch assembly in order to move the mass center in order to verify the axis of rotation and thereby balance the centrifugal clutch assembly.

### REFERENCE TO RELATED APPLICATION

This patent application claims priority under 35 U.S.C. § 119(e) to provisional patent application Ser. No. 60/590,708 entitled “Latch and Clutch Component Optimization Methods and Systems,” which was filed on Jul. 23, 2004, the disclosure of which is incorporated herein by reference.

### TECHNICAL FIELD

Embodiments are generally related to mechanical and electro-mechanical actuators, such as clutch mechanisms. Embodiments are also related to latch mechanisms and clutch mechanisms. Embodiments are additionally related to centrifugal clutches and components thereof, such as, for example, clutch springs. Embodiments are also related to automotive systems, such as automobile door latch systems and transmission systems.

### BACKGROUND OF THE INVENTION

Mechanical and electro-mechanical actuators are utilized in a variety of applications for operating devices and systems such automotive door latches, transmission systems, and so forth. An example of such a mechanical or electro-mechanical actuator is a centrifugal clutch, such as those used in power door lock operations.

In power door lock operations, for example, a drive motor can be utilized to reciprocally drive or shift a lift arm that is connected to a locking lever of a door latch assembly mounted in an automobile door. The lift arm is typically coupled to an output shaft of the drive motor via an intermediate gear train and operates to position the locking lever in either a locked or an unlocked position.

Additionally, the lift arm can be manually driven or shifted by either repositioning a door lock knob or slider, or by use of a door key. Since the gear train and output shaft are directly coupled to the lift arm, manually shifting the lift arm into the locked position requires driving the gear train and the output shaft, and shifting the lift arm into the unlocked position requires back driving the gear train and the output shaft. In both cases, the drive motor and gear train undesirably offer resistance to being manually driven/back driven by the door key, or by repositioning the door lock slider. Relatively speaking, the drive motor offers substantially greater resistance to being manually driven/back driven than the gear train.

The ease with which a lift arm can be manually shifted by use of a door key or door lock slider is referred to as the key effort or reversibility of the power door lock system which is a measure of the amount of resistance provided by the drive motor and gear train when the lift arm is manually shifted. Thus, the greater resistance provided by the gear train and the drive motor, the greater the key effort required to shift the lift arm and the higher the reversibility of the power door lock system.

One solution to the problem of driving/back driving the motor during manual operation is by use of a clutch such as a centrifugal clutch interposed between the output shaft of the drive motor and the gear train. The clutch operates to selectively mechanically couple the output shaft of the motor to the lift arm when the motor is activated, such as during a power door lock or unlock operation, and to decouple the output shaft from the lift arm when the motor is deactivated to thereby permit manual shifting of the lift arm without additionally driving/back driving the motor.

Thus, when the clutch decouples the motor from the lift arm, the key effort required to unlock the car door with a key, or by repositioning the door lock slider is desirably reduced. The key effort is reduced because only the lift arm, jack screw and gear train are driven/back driven without additionally driving/back driving the motor.

Centrifugal clutches for use in selectively establishing a mechanical driving connection between the output shaft and the lift arm have been implemented. A centrifugal clutch can be interposed between a drive motor output shaft and a gear train of a power door lock actuator. An example of such a conventional centrifugal clutch is disclosed in U.S. Pat. No. 5,862,903, “Centrifugal Clutch for Power Door Locks”, which issued on Jan. 26, 1999 and is incorporated herein by reference. One of the problems with conventional centrifugal clutch mechanisms is that such a device includes numerous parts such as springs, which can complicate the clutch design, reduce operational reliability of the clutch, complicate the manufacturing and assembly process, and ultimately increase manufacturing and maintenance costs, particularly if devices such as the springs are inherently flawed due to poor design configurations, which are inherently subject to stress and breakage, and ultimately poor life spans.

### BACKGROUND FOR THE FIRST EMBODIMENT

Some latch designs contain a spring with an axis parallel to the plane of intermediate sliders with two legs contacting each side of point C so that movement in either direction constitutes coiling of the spring. Such a design is inadequate because the movement of the spring is not purely in coiling the spring, but also along the axis, which functions to spread or compress the coils together. The stress on the two legs is thus too great, leading to premature failure of the latch incorporating such a spring and intermediate sliders.

### BACKGROUND FOR THE SECOND EMBODIMENT

Automotive latching systems may require the use of a clutch spring mechanism that includes a return spring, which generally biases the location of the abutment to the disengaged position. Some conventional designs can be overstressed, which leads to a short life cycle for the clutch spring mechanism. For example, the clutch and/or clutch spring mechanism can fracture during clutch testing.

It is thus desirable to optimize latching system components, such as, for example, spring mechanisms and in particular, clutch spring mechanisms and devices. The principal requirements for a successful spring design including tightening manufacturing tolerances, determining which forces the design actually requires (e.g., low and upper limits), and determining the maximum allowable footprint for the channel in order to provide the maximum design space available for further optimization and for meeting such requirements.

FIG. 1 illustrates a stress plot 100 for a conventional latch spring, which can be evaluated in order to determine optimal parameters for the design of an improved latch spring. Such a latch spring can be formed from a material such as, for example, BS-2056 302S26 (e.g., spring temper 302 SST), which is a very strong material having a tensile strength of approximately 325 kpsi. A Table A is illustrated below in association with FIG. 1 in order to summarize design iteration results for such an automotive latch spring. In Table A, all dimensions are in mm, all forces are in pounds, and stresses are in kpsi. Stress plot 100 of FIG. 1 is therefore associated with Table A.

FIG. 2 illustrates a stress plot 200 for a conventional latch spring, which can be evaluated in order to determine optimal parameters for the design of an improved latch spring. Again, such a latch spring can be formed from a material such as, for example, BS-2056 302S26 (e.g., spring temper 302 SST), which is a very strong material having a tensile strength of approximately 325 kpsi. A Table B is shown below in association with FIG. 2, in order to summarize design iteration results for such an automotive latch spring. In Table B, all dimensions are in mm, all forces are in pounds, and stresses are in kpsi. Stress plot 200 is therefore associated with Table B.

TABLE B

| | Wire | | | Outer | | Force | Force | |
|---|---|---|---|---|---|---|---|---|
| Case | Dia. | Length | Width | Loop R | #Loops | Assmb'd | Compr'd | Stress |
| Constant | 0.25 | 12.50 | 7.80 | 0.333 | 4.5 | 0.049 | 0.098 | 173.9 |
| Length | 0.30 | 12.50 | 7.80 | 0.40 | 4.5 | 0.101 | 0.207 | 199.1 |
| | 0.35 | 12.50 | 7.80 | 0.467 | 4.5 | 0.185 | 1.517* | 328.5* |
| | 0.40 | 12.50 | 7.80 | 0.533 | 4.5 | 0.314* | 34.782* | 1120.0* |
| Variable | 0.25 | 10.66 | 7.80 | 0.333 | 4.5 | 0.013 | 0.062 | 109.9 |
| Length | 0.30 | 12.50 | 7.80 | 0.40 | 4.5 | 0.101 | 0.207 | 199.1 |
| | 0.35 | 14.34 | 7.80 | 0.467 | 4.5 | 0.321 | 1.588* | 388.7* |
| | 0.40 | 16.18 | 7.80 | 0.533 | 4.5 | 0.773 | 30.317* | 1130.0* |

Note that FIGS. 1 and 2 along with Tables A-E described herein are referenced in order to explain why conventional latch springs do not meet the aforementioned principal requirements for a successful spring design, including tightening manufacturing tolerances, determining which forces the design actually requires (e.g., low and upper limits), and determining the maximum allowable footprint for the channel in order to provide the maximum design space available for further optimization and for meeting such requirements.

In general, the spring wire diameter can be adjusted in steps of 0.05 to determine the effect on performance. At the same time, a constant level of forming strain can be maintained at the corner bend radius. This is the strain that a manufacturer may require to incorporate into the material during the forming process, and is equivalent to the wire diameter divided by the diameter of the bend at the wire center line. This situation can be seen by looking at Table B and noting how the loop outer radius increases as the wire diameter also increases. Such a series can be repeated twice, first keeping the length constant and then allowing the length to increase or decrease based on corner bend radius changes, while maintaining all other aspects of the spring design constant.

One interesting phenomenon can occur when all of the loops begin to contact each other when the spring is at a full compression thereof. The forces and stresses increase. The reason for such an occurrence is that essentially all of the extra space is taken up, the loops collapse, and essentially only the loop ends begin to compress. FIG. 2 essentially demonstrates the stress plot 200 for the collapsed spring. The arrows 204 drawn between the loops shown reaction forces between loops that are in contact. Note that only a line is drawn rather than the full wire diameter (i.e., because line elements are utilized), but that loops do not become closer to each other or to the channel side walls than one wire diameter, because the wire thickness is taken into account in such a model.

The data of Tables A and B and stress plots 100 and 200 lead to a conclusion that wire diameter possesses a strong relationship to compression forces and stresses. In such tables and stress plots, a direct effect is due to wire diameter. Such an effect, however, is also an indirect result of the loop corner radius because it is increased to maintain the same wire corner radius/diameter ratio. Additionally, such an effect is also an indirect result of the spring length, which changes with wire diameter and outer loop radius. The effect on compression force is generally exaggerated for the last two cases (i.e., see constant length and variable length of Table B) because full loop compression occurs. Even disregarding this, however, it is interesting to note that the effect remains strong. Obviously, the smallest wire diameter can meet operating force requirements is best from a stress point of view.

Three independent optimizations can be run with the number of loops set at 3.5, 4.5, and 5.5, as indicated at Table C in order to determine if any designs better than prior designs can be found. The criteria utilized in such a scenario is that the spring should meet all force requirements (e.g., 0.100±0.008 lbs in the assembled position and 0.200±0.016 lbs in the compressed position), while not contacting the side rails during actuation. A further requirement is that all corner bend radii should possess low forming strain (e.g., bending radius to wire diameter ratio, in this case, equivalent to a 0.3 mm diameter bent on a 0.4 wire mm radius), so they would be manufacturable. Thus, the optimum design is preferably the one that possesses the lowest stress in a fully compressed state, which correlates directly to the longest life.

TABLE C

| | Wire | | | Outer | | Force | Force | |
|---|---|---|---|---|---|---|---|---|
| Case | Dia. | Length | Width | Loop R | #Loops | Assmb'd | Compr'd | Stress |
| | 0.231 | 13.444 | 6.359 | 0.670 | 3.5 | 0.107 | 0.184 | 345.3 |
| | 0.300* | 12.500* | 7.800* | 0.700* | 4.5* | 0.099* | 0.205* | 197.7* |
| | 0.251 | 13.454 | 6.395 | 0.618 | 5.5 | 0.102 | 0.191 | 243.6 |

In evaluating the data in Table C, it is important to note that dropping the number of loops to 3.5 results in an optimum that develops nearly twice the stress of 4.5 turns, and is represents the wrong direction for proceeding in latch spring design development. Increasing the number of loops to 5.5 offers more promise. Although the stress values in Table C demonstrate that 4.5 turns is better, 5.5 turns remains a preferred value. Intuitively, adding more turns means adding more wire, which lowers the stress. The only manner, in which more wire can be added, however, is if the maximum allow able length increases. The 5.5 turns is cramped, and tight corner radii are required to fit thereof, which produces higher corner stress. If another millimeter is allowed, such a parameter would permit the bend radius to increase slightly, which would lower stresses possibly below the 4.5 loop case stress. Increased length would obviously help the 4.5 loop case of Table C.

The question of whether stress levels are low enough to produce adequate life of a latch spring configuration depends on several factors. A typical rule of thumb is that stresses should be 50% of the ultimate tensile strength for infinite life. In this case, that would be 162.5 ksi, but the best optimal design remains above this value. Additionally, there is some mean stress always present due to the preload in the spring, and this will lower the fatigue life even more. Infinite life, however, may not be what is required. The only dependable answer is to rely on test data to determine if the design is adequate.

Tables D and E respectively represent additional data with respect to a conventional 4.5 loop configuration and a conventional 5.5 loop configuration. To interpret both tables, note that “r” indicates the outer loop radius and the value thereafter refers to length, while “w” refers to width, and “d” to wire diameter. “All” indicates that all of these variables are changed simultaneously.

TABLE D

| | Wire | | | Outer | | Force | Force | |
|---|---|---|---|---|---|---|---|---|
| Case | Dia. | Length | Width | Loop R | #Loops | Assmb'd | Compr'd | Stress |
| Nom.: | 0.30 | 12.46 | 7.64 | 0.70 | 4.5 | 0.106 | 0.218 | 205.8 |
| r − .1 | 0.30 | 12.46 | 7.64 | 0.60 | 4.5 | 0.109 | 0.220 | 218.3 |
| r + .2 | 0.30 | 12.46 | 7.64 | 0.90 | 4.5 | 0.099 | 11.269* | 857.0* |
| w − .26 | 0.30 | 12.46 | 7.38 | 0.70 | 4.5 | 0.117 | 0.240 | 220.0 |
| w + .26 | 0.30 | 12.46 | 7.90 | 0.70 | 4.5 | 0.096 | 0.198 | 192.9 |
| l − 1.5 | 0.30 | 10.96 | 7.64 | 0.70 | 4.5 | 0.041 | 0.149 | 147.4 |
| l + 1.5 | 0.30 | 13.96 | 7.64 | 0.70 | 4.5 | 0.169 | 0.288 | 271.1 |
| d − .02 | 0.28 | 12.46 | 7.64 | 0.68 | 4.5 | 0.080 | 0.161 | 196.2 |
| d + .02 | 0.32 | 12.46 | 7.64 | 0.72 | 4.5 | 0.137 | 0.291 | 222.3 |
| all (−) | 0.28 | 10.96 | 7.38 | 0.58 | 4.5 | 0.036 | 0.129 | 151.7 |
| all (+) | 0.32 | 13.96 | 7.90 | 0.92 | 4.5 | 0.189 | 15.487* | 976.3 |

TABLE E

| | Wire | | | Outer | | Force | Force | |
|---|---|---|---|---|---|---|---|---|
| Case | Dia. | Length | Width | Loop R | #Loops | Assmb'd | Compr'd | Stress |
| Nom.: | 0.252 | 13.454 | 6.395 | 0.618 | 5.5 | 0.103 | 0.193 | 244.1 |
| r − .1 | 0.252 | 13.454 | 6.395 | 0.518 | 5.5 | 0.107 | 0.184 | 254.2 |
| r + .2 | 0.252 | 13.454 | 6.395 | 0.818 | 5.5 | 0.098 | 13.606* | 1360.0* |
| w − .26 | 0.252 | 13.454 | 6.135 | 0.618 | 5.5 | 0.116 | 0.217 | 262.6 |
| w + .26 | 0.252 | 13.454 | 6.655 | 0.618 | 5.5 | 0.092 | 0.172 | 227.6 |
| l − 1.5 | 0.252 | 11.954 | 6.395 | 0.618 | 5.5 | 0.058 | 0.141 | 178.7 |
| l + 1.5 | 0.252 | 14.954 | 6.395 | 0.618 | 5.5 | 0.147 | 0.247 | 307.9 |
| d − .02 | 0.232 | 13.454 | 6.395 | 0.598 | 5.5 | 0.073 | 0.131 | 221.0 |
| d + .02 | 0.272 | 13.454 | 6.395 | 0.638 | 5.5 | 0.140 | 0.291 | 265.9 |
| all (−) | 0.232 | 11.954 | 6.135 | 0.498 | 5.5 | 0.049 | 0.111 | 189.6 |

| | | | | | | |
|---|---|---|---|---|---|---|
| all (+) | 0.272 | 14.954 | 6.655 | 0.838 | 5.5 | crashed, no data (but very high) |

The aforementioned Tables A-E and associated stress plots indicate that tolerances are very loose as compared to what is required. If a conventional spring latch is utilized as the maximum allowable assembly and compressed forces, then the conventional spring mechanism designs associated with Tables A-E and associated stress plots exceed these levels when tolerances are at their extremes.

The data associated with Tables A-E and the associated stress plots, indicates that the conventional spring upon which such data is based is barely able to meet the aforementioned principal requirements for a successful spring design, thereby rendering any designs based on such a conventional spring as unsatisfactory. Chief areas of concern for such a conventional spring design are that the stresses are too high, which can lead to poor fatigue life and also, that the manufacturing tolerances are too large to meet performance requirements.

### BACKGROUND FOR THE THIRD EMBODIMENT

A conventional clutch mechanism contains a return spring, which biases the location of the abutment to the disengaged position. Such a spring is typically implemented as a flat spring with multiple bends that provide the return force for the clutch slider when compressed. Such conventional clutch mechanisms and spring designs typically become overstressed, which leads to a short cycle life. Such conventional configurations may fracture during clutch testing after less than, for example, 26,000 cycles. Such a conventional design also incorporates a bend at each end of the wire, which can cause coil clashing upon compression.

### BACKGROUND FOR THE FOURTH EMBODIMENT

Conventional centrifugal clutches typically suffer from imbalance during operation, particularly in the context of motor and clutch assemblies. Such assemblies typically remain unbalanced during performance conditions. For example, upon testing a conventional clutch on a motor for 26,000 cycles, it has been observed that motor bearings wear significantly and therefore are predicted not to withstand the required cycles. Such an assembly must be accurately balanced in order to improve vibration and bearing life in the motor. Despite efforts to implement balancing in a centrifugal clutch such as, for example, utilizing software analysis tools to properly balance the centrifugal clutch assembly, it has been determined that such designs when subject to testing can wear away the contacts in the motor.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide for latch and clutch optimization methods and systems.

It is another aspect of the present invention to provide for methods and systems for optimizing intermediate sliders utilized in association with a spring in latch mechanisms.

It is a further aspect of the present invention to provide for methods and systems for optimizing clutch spring mechanisms.

It is yet an additional aspect of the present invention to provide for a leaf spring mechanism for use in a centrifugal clutch assembly.

It is also an aspect of the present invention to provide for methods and systems for balancing a centrifugal clutch.

The aforementioned aspects of the invention and other objectives and advantages can now be achieved as described herein. Latch and clutch component optimization methods and systems are disclosed herein. In accordance with a first embodiment, a slider spring system can be implemented that includes a plurality of intermediate sliders driven independently by a rotating index gear, wherein each intermediate slider among the plurality of intermediate sliders comprise at least one slot (preferably two slots) for controlling movement when contacted by the rotating index gear.

Such a system can also include a single spring for maintaining and retuning the plurality of intermediate sliders to a rest position after any of the plurality of intermediate sliders are moved by the rotating index gear. Each intermediate slider among the plurality of intermediate sliders can comprise: a Point A located at a center of the slot nearest the rotating index gear; a Point B located at a center of a straight slot nearest a pawl and the plurality of intermediate sliders; and a Point B located at a center of a contact for the single spring. Point B moves primarily along an x-axis to drive the pawl, a lock slider or a super lock slider, wherein the straight slot accommodates a movement of Point B primarily along the X-axis for driving the pawl, the lock slider or the super lock slider.

Point A generates adequate x-axis movement at the Point B while providing y-axis movement at Point A to allow the rotating index gear to clear when driving rotation thereof is completed. The single spring, when located at Point C returns an intermediate slider among the plurality of intermediate sliders to the rest position to await a subsequent movement by the rotating index gear. Such a single spring comprises a return spring. Additionally, the slot at the Point A can be configured to provide similar movement at the Point B while forcing a movement at the Point C to be radial or to the a natural path of the single spring during coiling thereof. Such intermediate sliders and the single spring can be adapted for use with a centrifugal clutch.

In accordance with a second embodiment, a spring apparatus can be implemented, which includes a spring for use in a clutch mechanism, wherein the spring is configured to avoid coil clash and end wire lengths of the spring are positioned in order to center the clutch spring without additional features thereof. Additionally, bend radii and a wire diameter associated with the spring. Such a spring can be adapted for use in a centrifugal clutch and/or an automobile latch.

In accordance with a third embodiment, a spring apparatus can be implemented, which includes a leaf spring for use in a clutch mechanism, wherein the leaf spring is configured to avoid coil clash and end wire lengths of the leaf spring are positioned in order to center the leaf spring without additional features thereof. Bend radii and a wire diameter associated with the leaf spring. The leaf spring can be adapted for use in a centrifugal clutch and/or automobile latch.

In accordance with a fourth embodiment, a methodology and system for balancing a centrifugal clutch can be implemented. A 3-dimensional model of a centrifugal clutch assembly in an engaged position thereof can be established and thereafter, a mass center of the centrifugal clutch assembly can be calculated. A distance from the axis of rotation of the centrifugal clutch assembly can be determined. Thereafter, associated part features of the centrifugal clutch assembly can be modified in order to move the mass center; and repeating as necessary establishing a 3-dimensional model of a centrifugal clutch assembly in an engaged position thereof, calculating a mass center of the centrifugal clutch assembly, determining a particular distance from an axis of rotation of the centrifugal clutch assembly, and modifying part features of the centrifugal clutch assembly in order to move the mass center in order to verify the axis of rotation and thereby balance the centrifugal clutch assembly.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a stress plot for a conventional latch spring, which can be evaluated in order to determine optimal parameters for the design of an improved latch spring;

FIG. 2 illustrates a stress plot for a conventional latch spring, which can be evaluated in order to determine optimal parameters for the design of an improved latch spring;

FIG. 3 illustrates a side view of an intermediate slider spring apparatus, in accordance with a first embodiment;

FIG. 4 illustrates a conventional latch spring;

FIG. 5 depicts a stress plot associated with the conventional spring depicted in FIG. 4;

FIG. 6 depicts a stress plot associated with the conventional spring depicted in FIG. 4;

FIG. 7 illustrates an improved latch spring, which can be implemented in accordance with the second embodiment;

FIG. 8 illustrates a defection plot of a spring, in accordance with the second embodiment;

FIG. 9 illustrates a stress plot of a spring in accordance with the second embodiment;

FIG. 10 illustrates a leaf spring, which can be adapted for use with a centrifugal clutch, in accordance with a third embodiment;

FIG. 11 illustrates a deflection plot of the leaf spring depicted in FIG. 10, in accordance with the third embodiment;

FIG. 12 illustrates a stress plot of the leaf spring depicted in FIG. 10, in accordance with the third embodiment;

FIG. 13 illustrates an alternative leaf spring, which can be adapted for use with a centrifugal clutch, in accordance with the third embodiment;

FIG. 14 illustrates a deflection plot of the alternative leaf spring depicted in FIG. 13, in accordance with the third embodiment;

FIG. 15 illustrates a stress plot of the alternative leaf spring depicted in FIG. 13, in accordance with the third embodiment;

FIG. 16 illustrates a high-level flow chart of logical operations, which can be implemented in order to balance a centrifugal clutch, in accordance with a fourth embodiment; and

FIG. 17 illustrates a block diagram of data-processing systems, which can be implemented in accordance with the fourth embodiment.

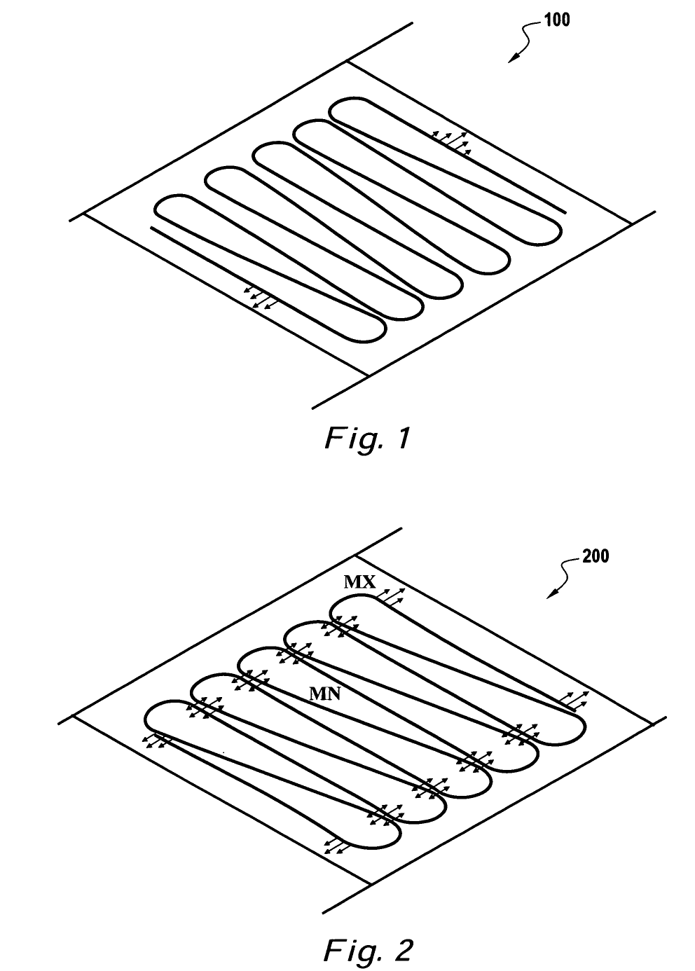

### DETAILED DESCRIPTION OF THE INVENTION

The particular values and configurations discussed in these non-limiting examples can be varied and are cited merely to illustrate at least one embodiment of the present invention and are not intended to limit the scope of the invention.

### First Embodiment: Intermediate Slider Optimization

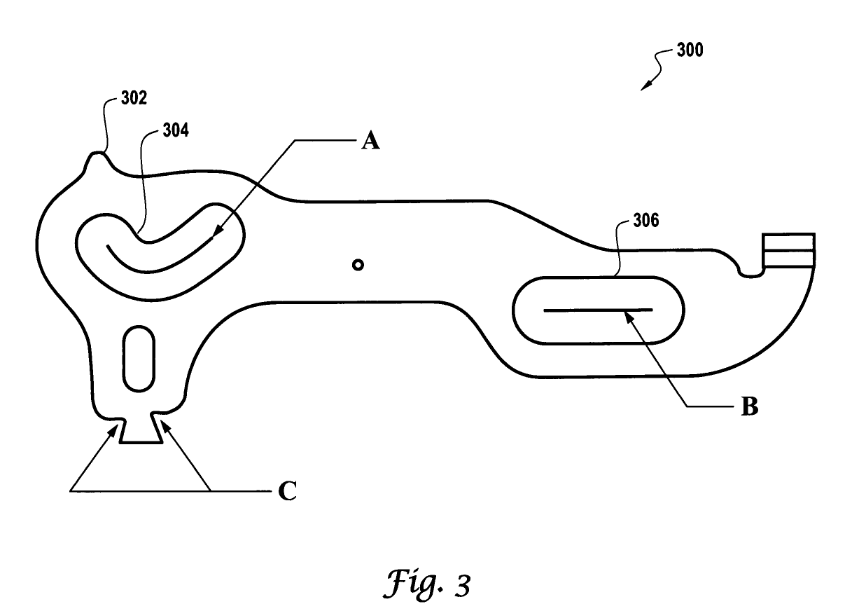

FIG. 3 illustrates a side view of an intermediate slider spring apparatus 300, which can be implemented in accordance with a first embodiment. As indicated earlier, some latch designs contain a spring with an axis parallel to the plane of intermediate sliders with two legs contacting each side of a Point C so that movement in either direction constitutes coiling of the spring. Such a design is inadequate because the movement of the spring is not purely in coiling the spring, but also along the axis, which functions to spread or compress the coils together. The stress on the two legs is thus too great, leading to premature failure of the latch incorporating such a spring and intermediate sliders.

In accordance with a first embodiment, an intermediate slider configuration for apparatus 300 can be implemented to solve the problem of fatigue failure in the intermediate slider return spring by specially designing a slot 304 at Point A to provide similar movement at Point B while forcing the movement at Point C to be radial to the natural path of the spring legs during coiling. Removing the axial movement of the spring and replacing it with pure radial movement therefore can allow the spring apparatus 300 to be applied as intended and extend the life of the spring to typical coil spring values. An abutment 302 configured from spring apparatus 300 can be contacted by an index gear. The intermediate slider rides on pins at points A and B, such that slots thereof can determine the working motion. Note that spring legs can make contact at point C.

The spring apparatus 300 can be rotated 90 degrees so that the axis is perpendicular to the plane of the intermediate sliders and the legs can be bent 90 degrees to contact the sliders at point C. Instead of leaving the spring movement as an afterthought, the movement at Point C can be used as a driver to the ultimate latch design. The slot 306 at Point B can be used to retain the x-axis movement at Point B, but the slot 304 at Point A, which originally was implemented as an inverted V pattern, can be redefined by the movement at B and C as drivers. CAD (Computer Aided Design) software, including 3-dimensional design software thereof, can be utilized to dictate the movement at B and C, and plot the resultant movement at Point A. A slot can then be generated from the resultant path and incorporated into the intermediate sliders. Once the optimized slot at A is defined, the model thereof can be easily confirmed by moving the drivers of the motion to Point A and Point B while plotting travel at Point C. The radial path center at Point C thus defines the axis center of the spring.

Three intermediate sliders can be driven independently by a rotating index gear. A single spring can maintain and return all intermediate sliders to a rest position after any of the three are moved by the index gear. Two slots in the intermediate slider can control the movement of this part when contacted by the index gear. It can be appreciated, of course, that reference to “three” intermediate sliders is provided for illustrative purposes only. In accordance with alternative embodiments, additional intermediate sliders may be implemented, depending upon design considerations.

For illustrative purposes, movement can be described by reference to three points on the intermediate slider. At the center of the slot nearest the index gear, Point B is the center of the straight slot nearest the pawl and sliders, whereas Point C is the center of contact for the return spring. Point B should preferably move along the x-axis to drive either a pawl or a super lock slider (i.e., depends on which intermediate slider is being driven). The straight slot 306 at Point B can accommodate this requirement. The slot 304 at Point A is more complicated because it must generate adequate x-axis movement at Point B, while also providing y-axis movement at Point A to allow the index gear to clear when driving rotation is completed. When the index gear drives and then clears the intermediate slider, the spring at Point C returns the intermediate slider to the rest position to await a subsequent movement by the index gear.

Automotive latching systems may require the use of a clutch spring mechanism that includes a return spring, which generally biases the location of the abutment to the disengaged position. Some conventional designs can be overstressed, which leads to a short life cycle for the clutch spring mechanism. For example, the clutch and/or clutch spring mechanism can fracture during clutch testing.

It is thus desirable to optimize latching system components, such as, for example, spring mechanisms and in particular, clutch spring mechanisms and devices. The principal requirements for a successful spring design including tightening manufacturing tolerances, determining which forces the design actually requires (e.g., low and upper limits), and determining the maximum allowable footprint for the channel in order to provide the maximum design space available for further optimization and for meeting such requirements.

An embodiment can thus be implemented to optimize a clutch spring mechanism design by determining the optimum number of coils and shape while utilizing standard bend radii and wire diameter. The end of wire bends, for example, can be eliminated to avoid coil clash, while the end wire length can be modified to center the spring without added features. The overall size and the pocket containing the spring can thus be increased. The bend radius can be increased to an acceptable manufacturing size.

In general, sidewalls of the channel containing the spring can be implemented, and two-dimensional surface-to-surface contact elements can be added to create real-world boundaries. With such contact elements in place, spring flexure can be restricted if any of the loops thereof bump into each of the channel wall. A suggested coefficient of friction for modeling such a device can be, for example, a coefficient of friction of 0.3. It can be appreciated of course, that such a value is merely presented for illustrative purposes only and is not considered a limiting feature of the embodiments disclosed herein.

Contact elements can also be strung between each loop of the spring. Unlike conventional spring mechanisms, however, this type of contact element can be configured to take into consideration the thickness of the wire, while not allowing for the center line of each loop to move closer than the wire diameter.

Coil self-contact and contact with the walls can also be monitored. A self-contact (i.e., contact of one loop to the other) is acceptable, but contact between the loops and side walls is not acceptable. The chief reason for such choices is that if there is any relative motion during contact (e.g., friction with the walls), such relative motion during contact may wear away the wire and lead to failure. In conventional systems, this is especially a problem at the outside edges of the loop, which is the most likely spot to contact the channel side thereof, because stresses are highest at this point and any loss in wire thickness can result in serious damage to the actual coil and spring mechanism system. Conversely, when the loops touch each other, as in self-contact, there will likely be very little relative motion and so very little wearing should occur that such a situation is likely a benign contact. Such features represent significant improvements to replicate improved latching spring mechanisms.

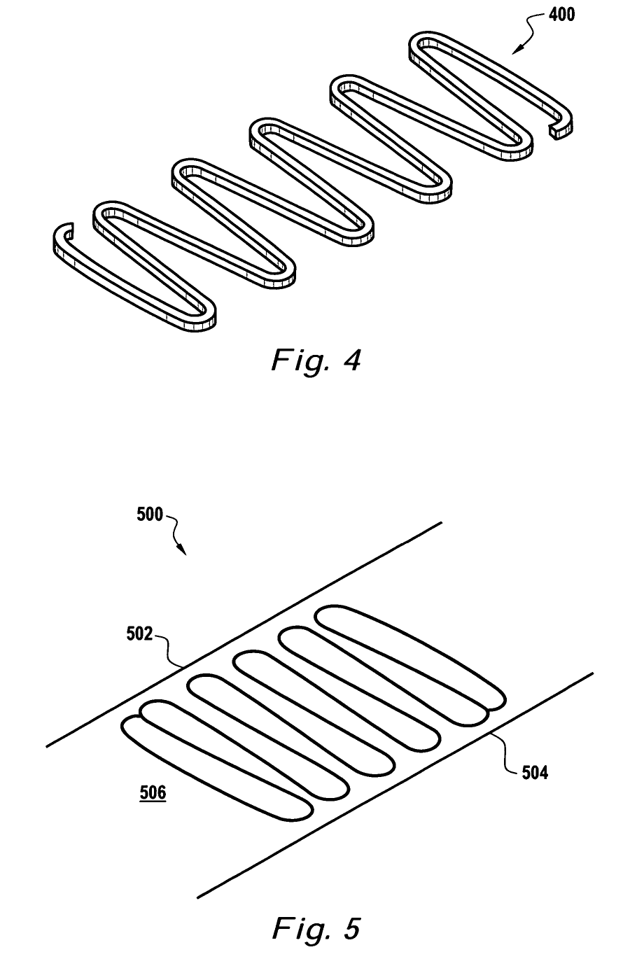

FIG. 4 illustrates a conventional latch spring 400, which is subject to several problems, including the inability to meet the aforementioned principal requirements for a successful spring design including tightening manufacturing tolerances, determining which forces the design actually requires (e.g., low and upper limits), and determining the maximum allowable footprint for the channel in order to provide the maximum design space available for further optimization and for meeting such requirements. Spring 400 suffers from a short fatigue life, because spring 400 tends to contact itself when compressed, thereby resulting in early fatigue failure. Such a condition is known as “coil clash”. Thus, any successful design for a latch spring should not allow “self-contact” anywhere in the spring.

Note that in the illustration of FIG. 4, the cross-section of spring 400 is actually circular, rather than square as shown therein. The dimensions of spring 400 generally include a diameter of 0.2 mm, a formed width of 3.9 mm with 0.4 outer corner radii, an overall length of approximately 10 mm and a total of 4.5 loops. For wire drawn to this small of a diameter, the tensile and yield stresses are approximately the same (e.g., 325 ksi). This is a very high strength material and there is apparently very little room for additional strain before the material breaks. A sample of spring 400 can be tested by bending one loop of spring 400 up, so that it will be found to break after only approximately 45 degrees deflection, verifying this extreme condition.

FIG. 5 depicts a stress plot 500 associated with the conventional spring 400 depicted in FIG. 4. Thus, data associated with conventional spring 400 is generally shown in stress plot 500 of FIG. 5. In stress plot 500, the side rails 502, 504 represent the edge of the channel 506 that the spring is intended to be trapped within. Note that the displacement and stress plots are shown as line plots.

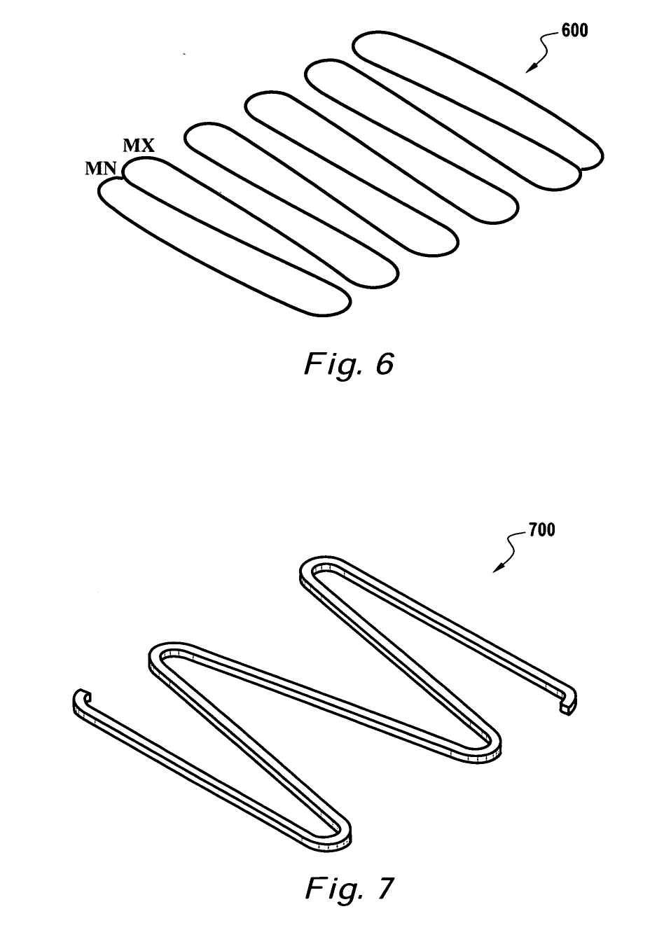

FIG. 6 depicts a stress plot 600 associated with the conventional spring 400 depicted in FIG. 4. Note that in FIG. 6, colors are generally superimposed on the lines for stress plots to indicate stress value versus location. Also note that the model of stress plot 500 in association with conventional spring 400 accounts for the actual thickness of the spring 400, even though such a thickness is not actually shown in such a plot.

Stress plot 500 generally indicates the spring compression forces for the conventional spring 400 were found to be as follows:
2.5 mm compression: 0.15956 lbs., and coil clash does occur at this level of compression.
5.0 mm compression: 0.33769 lbs., and coil clash remains at this level of compression.

With so much coil clash occurring, spring 400 is effectively always in self-contact, regardless of whether spring 400 is in a low or high compressed state. Thus, spring 400 represents a poor spring design. Spring 400 is therefore likely to be compressed in unexpected manners, due to self-contact, during the switching cycle. In addition, as the spring contacts itself, gouges, or is subject to wear, design life is further reduced.

The basic problem with spring 400, as evidence by stress plots 500 and 600, is the difficulty involved in maintaining current forces at compressions of 2.5 and 5.0 mm, while lowering stresses to prolong life. To solve this problem, three approaches can be taken. An improved spring design should preferably use round wire only, possess a rectangular cross-section (e.g., a leaf spring), and repeat the latter, while removing the curled end of the spring that tends to touch itself when the spring is compressed.

Additionally, an improved spring design that overcomes the problems of spring 400 can be implemented in the context of an expanded design space, thereby allowing for larger springs. The maximum formed spring width can be increased from a conventional value of, for example 3.9 mm to 10 mm (0.400″), while the maximum spring height (e.g., for the case of a leaf spring) can be increased from a conventional value of, for example, 0.2 mm up to 3.2 mm (0.125″). In an improved spring design, the number of loops can also be allowed to vary from a conventional value of, for example, 4.5 to whatever an amount is required. Finally, the outer corner radius of the improved spring can be allowed to vary from a conventional value of, for example, 0.4 mm, to whatever value functions the best, with one exception.

Because bare wire stock is formed into the spring (likely at elevated temperatures to be able to withstand the amount of strain that is required), it has been determined that the corner radius/thickness ratio should preferably not become too small or the wire will likely break during formation thereof. Thus, to provide a realistic limitation, the amount of strain at the corner bend should likely not exceed a value of 33%. Such a value can be calculated simply by dividing the outer radius minus the center-line radius of the spring by the same center-line radius.

Some general trends and observations can be set forth at this point. Decreasing the number of loops can prevent coil clash, but doing so may also increase compression forces and stresses. Additionally, increasing the wire diameter can increase stress and compression forces greatly. Increasing the spring width tends to decrease stress and compression force. Finally, increasing the corner bend radius tends to decrease stress and force.

FIG. 7 illustrates an improved latch spring 700, which can be implemented in accordance with the second embodiment. Spring 700 can be implemented in the context of round wire configurations. Spring 700 may include a wire diameter of approximately 0.31 mm, along with the number of loops at 1.5, an outside corner bend radius of approximately 0.70 mm, and a formed spring width of approximately 9.9 mm. The design of spring 700 can possess a maximum stress of 378 ksi. It is important to note that such parameters are merely illustrative values only and are presented in the context of one possible example. Thus, other parameters can be implemented in accordance with alternative versions of the second embodiment.

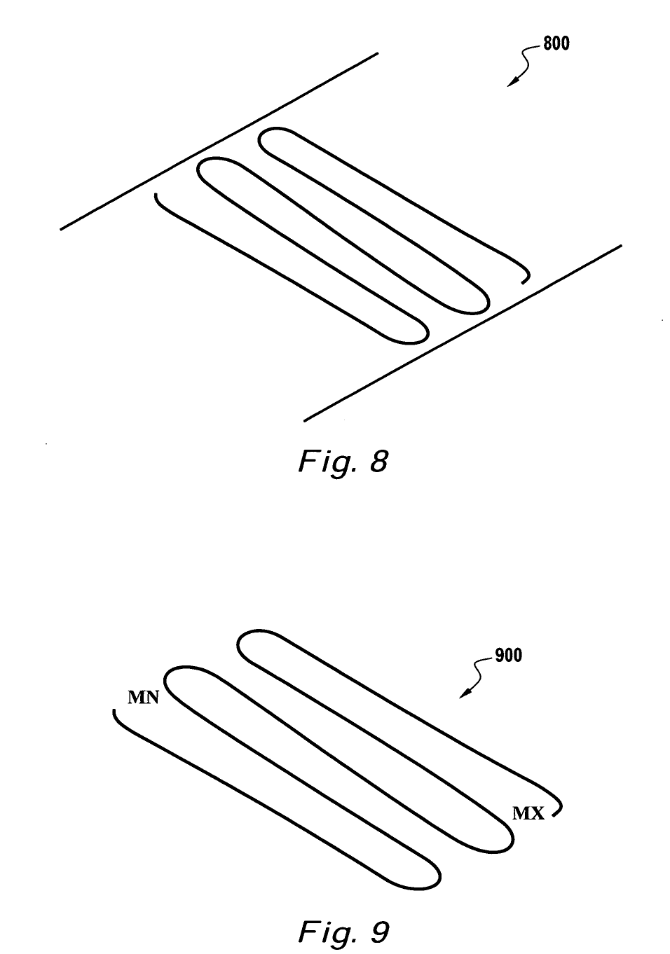

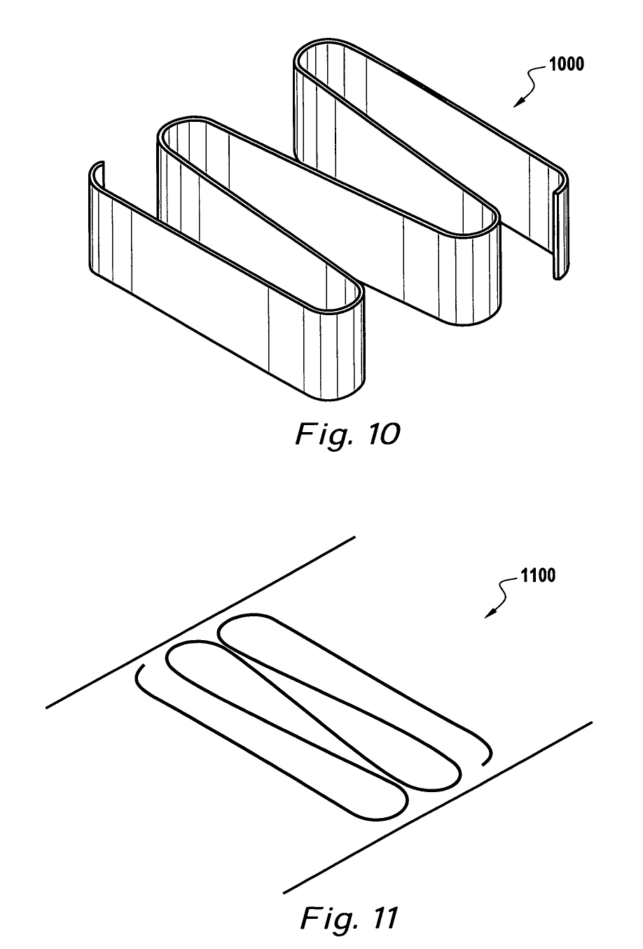

FIG. 8 illustrates a defection plot of spring 700, in accordance with the second embodiment. FIG. 9 illustrates a stress plot of spring 700 in accordance with the second embodiment. Note that the cross-section is actually circular, even though it appears as a square, due to CAD software graphic output. Based on FIGS. 8-9, it can thus be appreciated that although the number of cycles to failure is unknown, an overall improvement to both performance and stress resistance is evident. Spring 700 therefore contains an optimum number of coils and shape while utilizing standard bend radii and wire diameter. The end of wire bends can be eliminated in spring 700 in order to avoid coil clash. Additionally, the end wire length of spring 700 is modified to center spring 700 without additional support features. The overall size and the pocket containing spring 700 can be increased. The bend radius can also be increased to a manufacturing acceptable size.

### Third Embodiment: Leaf Spring Design for Centrifugal Clutch

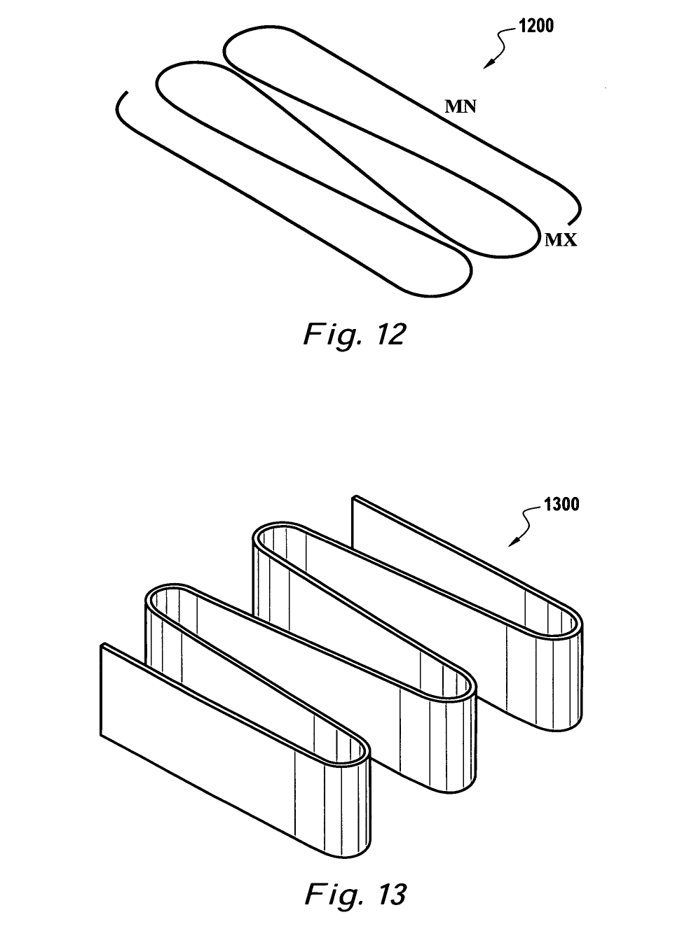

FIG. 10 illustrates a leaf spring 1000, which can be adapted for use with a centrifugal clutch, in accordance with a third embodiment. Leaf spring 1000 represents an optimal design with a rectangular cross-section and a shape that is somewhat reminiscent of “linguine” pasta. In the example of FIG. 10, leaf spring 1000 can possess a wire cross-sectional with of approximately 0.13 mm, a wire cross-sectional height of approximately 3.0 mm, a number of loops of 1.5, an outside corner bend radius of 1.0 mm, and a formed spring width of 10 mm. The design of leaf spring 1000 can possess a maximum stress of, for example, 138 ksi. It can be appreciated, of course, that such parameters are merely suggested values and are not considered limited features of the third embodiment. Such parameters are presented merely for illustrative and exemplary purposes only. FIG. 10 generally represents an element plot of leaf spring 1000. FIG. 11 illustrates a deflection plot 1100 of leaf spring 1000, while FIG. 12 represents a stress plot 1200 of leaf spring 900.

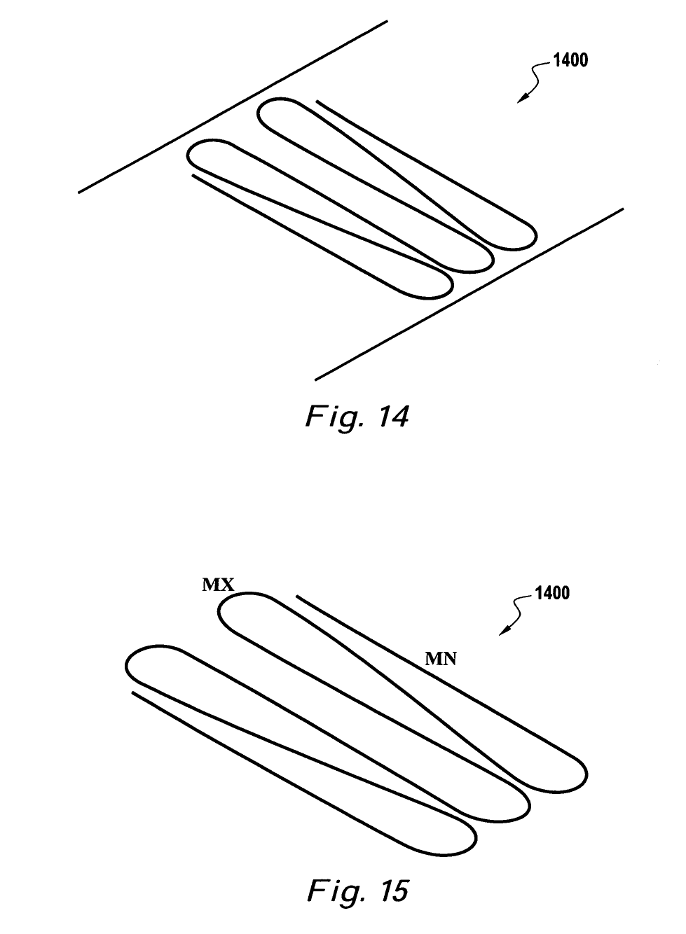

FIG. 13 illustrates an alternative leaf spring 1300, which can be adapted for use with a centrifugal clutch, in accordance with the third embodiment. FIG. 14 illustrates a deflection plot 1400 of the alternative leaf spring 1300 depicted in FIG. 13, in accordance with the third embodiment. FIG. 15 illustrates a stress plot 1500 of the alternative leaf spring 1300 depicted in FIG. 13, in accordance with the third embodiment. Leaf spring 1300 represents another optimal design for a spring mechanism for use a clutch, such as a centrifugal clutch. Leaf spring 1300 can be implemented as a small leaf spring (i.e., rectangular cross-section with a shape somewhat like “linguine” pasta). Leaf spring 1300 is similar to leaf spring 1000, but is implemented without the little curled ends of the spring, which are removed so that they do not exacerbate “coil clash”.

In general, leaf spring 1300 can possess a wire-cross sectional width of approximately 0.14 mm, a wire cross-sectional height of approximately 3.1 m, a number of loops of 2.0, an outside corner bend radius of approximately 0.8 mm formed spring width of approximately 10 mm. Such a design can possess a maximum stress of approximately 110 ksi. It can be appreciated, of course, that such parameters are merely suggested values and are not considered limited features of the third embodiment. Such parameters are presented merely for illustrative and exemplary purposes only.

The aforementioned leaf spring embodiments thus represent an even greater improvement over round wire. Such a design is preferred because another half of loop spring can potentially be added with causing coil clash. By implementing such leaf spring embodiments, stresses can be decreased by approximately 80% over conventional spring mechanisms and can operate at safe levels so that the spring can possess infinite life.

### Fourth Embodiment: Centrifugal Clutch CAD Balanced Design

Conventional centrifugal clutches typically suffer from imbalance during operation, particularly in the context of motor and clutch assemblies. Such assemblies typically remain unbalanced during performance conditions. For example, upon testing a conventional clutch on a motor for 26,000, it has been observed that motor bearings wear significantly and therefore are predicted not to withstand the required cycles. Such an assembly must be accurately balanced in order to improve vibration and bearing life in the motor. Despite efforts to implement balancing in a centrifugal clutch such as, for example, utilizing software analysis tools to properly balance the centrifugal clutch assembly, it has been determined that such designs when subject to testing can wear away the contacts in the motor.

In accordance with a fourth embodiment, an analysis tool can be utilized to assemble a 3-dimensional model of the clutch into its engaged position. A 3-dimensional model of the clutch can be assembled utilizing an analysis tool, such as 3-dimensional CAD software. The mass center of the clutch assembly can then be calculated. Thereafter, the distance from the axis of rotation can be determined and the part features thereof modified in order to move the mass center. The model analysis can then be rerun. The prior steps can then be rerun until the product mass center is on the axis of rotation. Additional components for rotating the clutch, such as a pinion gear GA, can also be considered utilizing this procedure in order to ensure overall proper balancing.

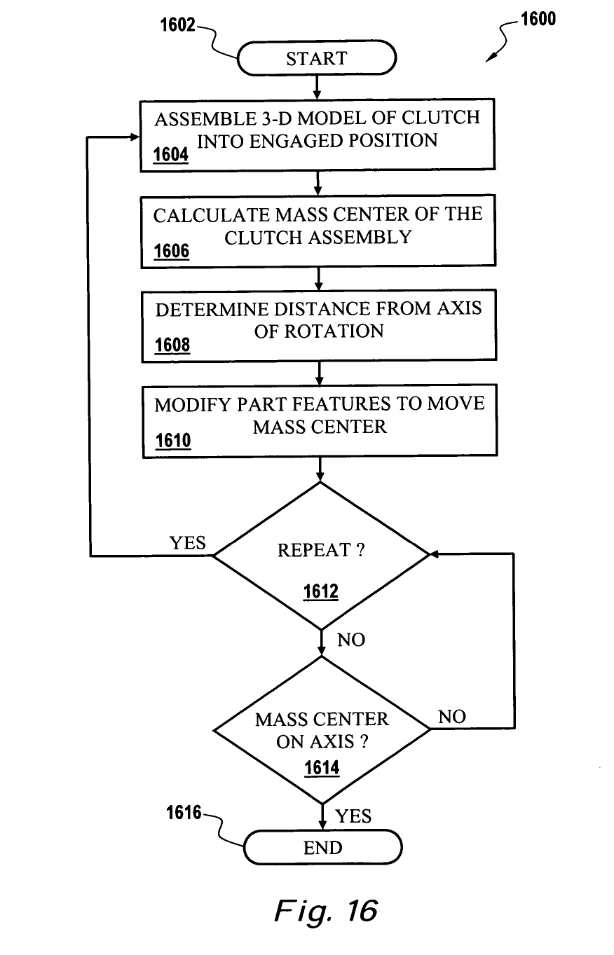

FIG. 16 illustrates a high-level flow chart 1600 of logical operations, which can be implemented in order to balance a centrifugal clutch, in accordance with a fourth embodiment. As indicated at block 1602, the process can be initiated. Thereafter, as depicted at block 1604, a 3-dimensional model of the clutch into its engaged position. Next, as indicated at block 1606, the mass center of the clutch assembly can be calculated. Thereafter, as described at block 1608, the distance from the axis of rotation can be determined, followed by processing of the operation depicted at block 1610, in which the part features thereof are modified in order to move the mass center. The model analysis can then be rerun as indicated at block 1612 (i.e., repeat analysis . . . yes or no?). The prior steps can then be rerun until the product mass center is verified on the axis of rotation, as depicted at block 1615. Additional components for rotating the clutch, such as a pinion gear GA, can also be considered utilizing this procedure in order to ensure overall proper balancing. The process can then terminate, as indicated at block 1616.

It can be appreciated that the operational steps depicted in FIG. 16 generally represent operations that may be utilized in accordance with a variety of embodiments. Such operational steps can be utilized to implement methods, systems and program products thereof. Such operational steps may also be implemented in the form of software modules. Such modules are generally collections of routines and data structures that perform particular tasks or implement particular abstract data types and/or instructions for processing via a processor and/or other data-processing device. Modules are typically composed of two portions: an interface, which lists constants, data types, variables, routines, subroutines, and so forth, which may be accessed by other modules, routines, or subroutines; and an implementation, which is accessible only to the module and which contains source code that actually implements the routines in the module.

Thus, for example, the operation depicted at block 1604 can be implemented as a module for assembling a 3-dimensional model of the clutch into its engaged position. Similarly, the operation depicted at block 1606, can be implemented as a module for calculating the mass center of the clutch assembly. The operation described at block 1608 can be implemented as module for determining the distance from the axis of rotation. The operation illustrated at block 1610 can be implemented as a module for modifying part features of the clutch assembly order to move the mass center. The operation described at block 1612 can be implemented as a module which determines whether or not to repeat the operations indicated at blocks 1604 to 1610. Similarly, the operation indicated at block 1614 can be implemented as a module for verifying that the product mass center is verified on the axis of rotation, as depicted at block 1615. Such modules can be stored in a memory unit of a data-processing system and processed via one or more microprocessors associated with such a system.

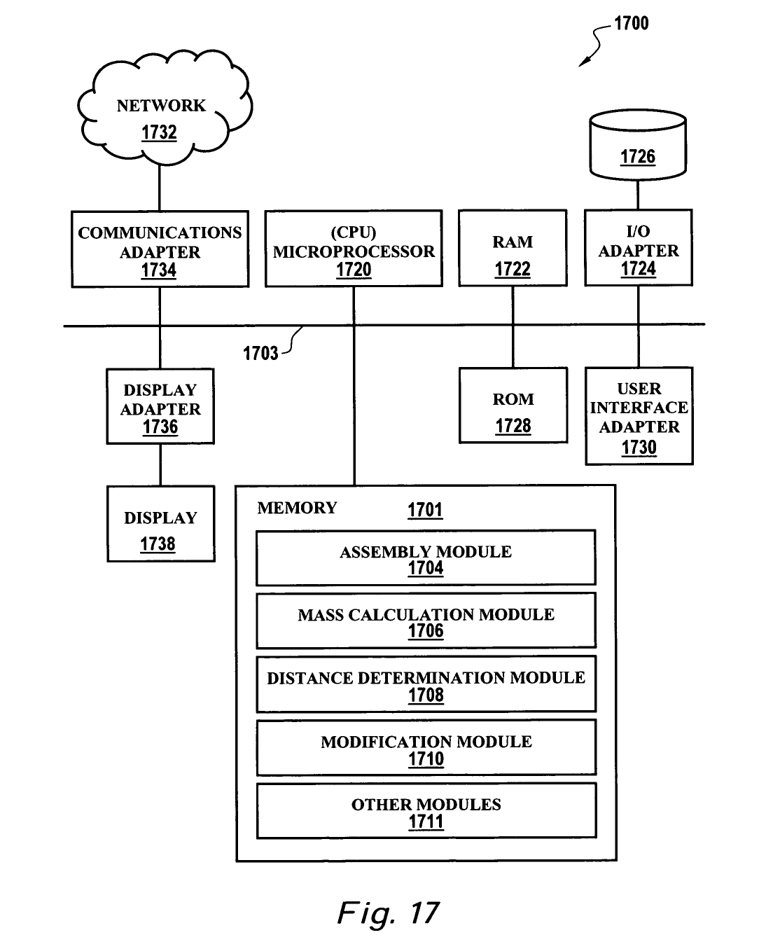

FIG. 17 illustrates a data-processing system 1700, which can be implemented in accordance with the fourth embodiment. In general, system 1700 can include a CPU (Central Processing Unit) 1720, such as a conventional microprocessor, and a number of other units interconnected via system bus 1703. System 1700 includes random access memory (“RAM”) 1722, read only memory (“ROM”) 1728, display adapter 1736, which can connect to a display device 1738, and I/O adapter 1724 for connecting peripheral devices (e.g., disk and tape drives 1726 ) to system bus 1703. Data-processing system 1700 can further include a user interface adapter 1730 for connecting devices such as a keyboard, mouse, speaker, microphone, and/or other user interface devices, such as a touch screen device (not shown), to system bus 1703. Communication adapter 1734 can connect data-processing system 1700 to a data-processing and or computer network 1732 such as, for example, the Internet or World Wide Web.

Data-processing system 1700 also includes a plurality of modules that reside within a memory 1701 in the context of machine-readable media to direct the operation of data-processing system 1700. Any suitable machine-readable media may retain such modules, such as memory 1700, RAM 1722, ROM 1728, a magnetic diskette, magnetic tape, or optical disk (the last three being located in disk and tape drives 1726). Any suitable operating system and associated graphical user interface (e.g., Microsoft Windows) can direct microprocessor 1720.

A module 1704 for assembling a 3-dimensional model of the clutch into its engaged position can be maintained by memory 1701. Similarly, a mass calculation module 1706 for calculating the mass center of the clutch assembly can be stored within memory 1701. Also, a distance determination module 1708 for determining the distance from the axis of rotation can be stored within memory 1701. A modification module 1710 for modifying part features of the clutch assembly order to move the mass center can be also be stored within memory 1701. Finally, other modules for performing other operations can also be stored within memory 1701, including modules which function as the operation system for data-processing system 1701.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

The description as set forth is not intended to be exhaustive or to limit the scope of the invention. Many modifications and variations are possible in light of the above teaching without departing from the scope of the following claims. It is contemplated that the use of the present invention can involve components having different characteristics. It is intended that the scope of the present invention be defined by the claims appended hereto, giving full cognizance to equivalents in all respects.

The embodiments of the invention in which an exclusive property or right is claimed are defined as follows. Having thus described the invention what is claimed is:

1. A method for balancing a centrifugal clutch, said method comprising the steps of:
establishing a 3-dimensional model of a centrifugal clutch assembly in an engaged position thereof;
calculating a mass center of said centrifugal clutch assembly; and
determining a particular distance from an axis of rotation of said centrifugal clutch assembly.

2. The method of claim 1 further comprising the steps of:
thereafter modifying part features of said centrifugal clutch assembly in order to move said mass center.

3. The method of claim 2 further comprising the step of:
thereafter repeating as necessary establishing a 3-dimensional model of a centrifugal clutch assembly in an engaged position thereof.

4. The method of claim 2 further comprising the step of:
thereafter repeating as necessary calculating a mass center of said centrifugal clutch assembly.

5. The method of claim 2 further comprising the step of:
thereafter repeating as necessary determining a particular distance from an axis of rotation of said centrifugal clutch assembly.

6. The method of claim 2 further comprising the step of:
thereafter repeating as necessary modifying part features of said centrifugal clutch assembly in order to move said mass center in order to verify said axis of rotation and thereby balance said centrifugal clutch assembly.

7. A method for balancing a centrifugal clutch, said method comprising the steps of:
establishing a 3-dimensional model of a centrifugal clutch assembly in an engaged position thereof;
calculating a mass center of said centrifugal clutch assembly;
determining a particular distance from an axis of rotation of said centrifugal clutch assembly; and
thereafter modifying part features of said centrifugal clutch assembly in order to move said mass center; and repeating as necessary establishing a 3-dimensional model of a centrifugal clutch assembly in an engaged position thereof, calculating a mass center of said centrifugal clutch assembly, determining a particular distance from an axis of rotation of said centrifugal clutch assembly, and modifying part features of said centrifugal clutch assembly in order to move said mass center in order to verify said axis of rotation and thereby balance said centrifugal clutch assembly.

8. A system for balancing a centrifugal clutch, comprising:
assembly module for establishing a 3-dimensional model of a centrifugal clutch assembly in an engaged position thereof;
mass calculation module for calculating a mass center of said centrifugal clutch assembly; and
distance determination module for determining a particular distance from an axis of rotation of said centrifugal clutch assembly.

9. The system of claim 8 further comprising:
modification module for thereafter modifying part features of said centrifugal clutch assembly in order to move said mass center.

10. The system of claim 9 further comprising:
module for thereafter repeating as necessary establishing a 3-dimensional model of a centrifugal clutch assembly in an engaged position thereof.

11. The system of claim 9 further comprising:
module for thereafter repeating as necessary calculating a mass center of said centrifugal clutch assembly.

12. The system of claim 9 further comprising:
module for thereafter repeating as necessary determining a particular distance from an axis of rotation of said centrifugal clutch assembly.

13. The system of claim 9 further comprising:
module for thereafter repeating as necessary modifying part features of said centrifugal clutch assembly in order to move said mass center in order to verify said axis of rotation and thereby balance said centrifugal clutch assembly.

14. The system of claim 9 wherein each of said modules are stored within a memory.

15. The system of claim 14 further comprising a microprocessor for processing each of said modules stored within said memory.

16. The system of claim 15 wherein said microprocessor communicates with said memory.

17. The system of claim 15 further comprising:
a modification module for thereafter modifying part features of said centrifugal clutch assembly in order to move said mass center; and
a module for repeating as necessary establishing a 3-dimensional model of a centrifugal clutch assembly in an engaged position thereof, calculating a mass center of said centrifugal clutch assembly, determining a particular distance from an axis of rotation of said centrifugal clutch assembly, and modifying part features of said centrifugal clutch assembly in order to move said mass center in order to verify said axis of rotation and thereby balance said centrifugal clutch assembly.

18. The system of claim 17 wherein each of said modules are stored within a memory.

19. The system of claim 18 further comprising a microprocessor for processing each of said modules stored within said memory.

20. The system of claim 19 wherein said microprocessor communicates with said memory.
